(19) United States
(12) Patent Application Publication
(10) Pub. No.: US 2016/0295004 A1
(43) Pub. Date: Oct. 6, 2016

(54) METHODS FOR DISPLAYING CUSTOMER OR REMOTE PARTY INFORMATION BASED ON LOCATION DATA

(71) Applicant: Interactive Intelligence Group, Inc., Indianapolis, IN (US)

(72) Inventor: John Clark, Chapel Hill, NC (US)

(73) Assignee: Interactive Intelligence Group, Inc.

(21) Appl. No.: 14/678,004

(22) Filed: Apr. 3, 2015

(51) Int. Cl. H04M 1/725; H04M 3/42; H04W 4/02; H04M 3/523

(52) U.S. Cl. CPC H04M 1/72572; H04M 3/5232; H04M 3/42348; H04W 4/028

(57) ABSTRACT

Methods for displaying customer or remote party information based on location data are provided. In one example, a method includes the steps of receiving a phone call via a mobile phone and receiving location information via the mobile phone. A customer associated with the location information is determined, the phone call is routed to a contact center agent, and customer information associated with the customer is displayed in a graphical user interface.

### FIELD

This invention relates generally to contact centers, and more specifically to displaying customer or remote party information based on location data.

### BACKGROUND

In a conventional contact center, contact center agents may step through a time consuming routine to establish why a caller needs assistance. Such inefficiencies consume valuable call center resources. Thus there is a need for new methods to determine caller information.

### SUMMARY

Embodiments of the invention provide caller information based on location data. An exemplary method may comprise the steps of receiving a phone call via a mobile phone; receiving location information via the mobile phone; and matching a customer record with the location information. The method may further comprise the steps of routing the phone call to a contact center station comprising a graphical user interface, and displaying customer information associated with the customer in the graphical user interface.

Another exemplary method may comprise the steps of receiving an incoming communication, determining location information associated with the incoming communication, matching the location information with a database record, routing the incoming communication to a contact center station comprising a graphical user interface, and displaying information associated with the database record in the graphical user interface.

Further embodiments, features, and advantages of the invention, as well as the structure and operation of the various embodiments of the invention are described in detail below with reference to the accompanying drawings.

### BRIEF DESCRIPTION OF THE DRAWINGS

The accompanying drawings, which are incorporated herein and form a part of the specification, illustrate the present invention and, together with the description, serve to explain the principles of the invention and to enable a person skilled in the pertinent art to make and use the invention.

FIG. 1 is a flow chart illustrating a method according to an embodiment.

FIG. 2 is a flow chart illustrating a method according to another embodiment.

FIG. 3 is a diagram illustrating a system according to an embodiment.

### DETAILED DESCRIPTION

Embodiments are described for displaying customer or remote party information based on location data. In one exemplary embodiment a contact center system handles incoming phone calls and routes calls to contact center agents. Location information received via a mobile device may be used to determine a customer record and display this information to a contact center agent to facilitate the conversation between the contact center agent and the caller.

During a typical workday, a field technician, such as an electrician, may be dispatched on one or more service calls to install, activate, repair, deactivate, or remove customer equipment. During a service call, the field technician may be required to perform some or all of the work on the customer premises. However, some aspects of the service procedure may require support from a manager or other representative to assist with the service call, such as turning on or off an electrical service to the customer. Aspects of the invention may improve service calls by displaying customer or remote party information based on location data. While on a service call, the remote field technician requires assistance, and calls a contact center through a contact center application executing on a mobile device, such as a smartphone. During the phone call the contact center application may send location information to the contact center system, such as the current Global Positioning System (G.P.S.) coordinates of the smartphone.

The contact center system may use the location information to determine a matching customer associated with the phone call. G.P.S. coordinates, for example, may be matched with a street address. One or more databases may be searched for customer records with a matching street address, or for the closest address matching the G.P.S. coordinate.

While the phone call is routed to a contact center station with a graphical user interface, information associated with the matching customer may be displayed in the graphical user interface. By displaying matching customer information, the conversation between a contact center agent and the field technician may immediately begin with this baseline information, dispensing with a time-consuming preliminary conversation to determine which customer the field technician is calling about.

### Illustrated Methods

Selected methods are illustrated and described for displaying customer or remote party information based on location data. By displaying customer or remote party information based on location data, contact center interactions can be shortened by reducing the need for agents to determine the reason for a phone call before resolving the underlying issue. As a result, contact center loads are reduced as contact center agents more efficiently handle contact center calls.

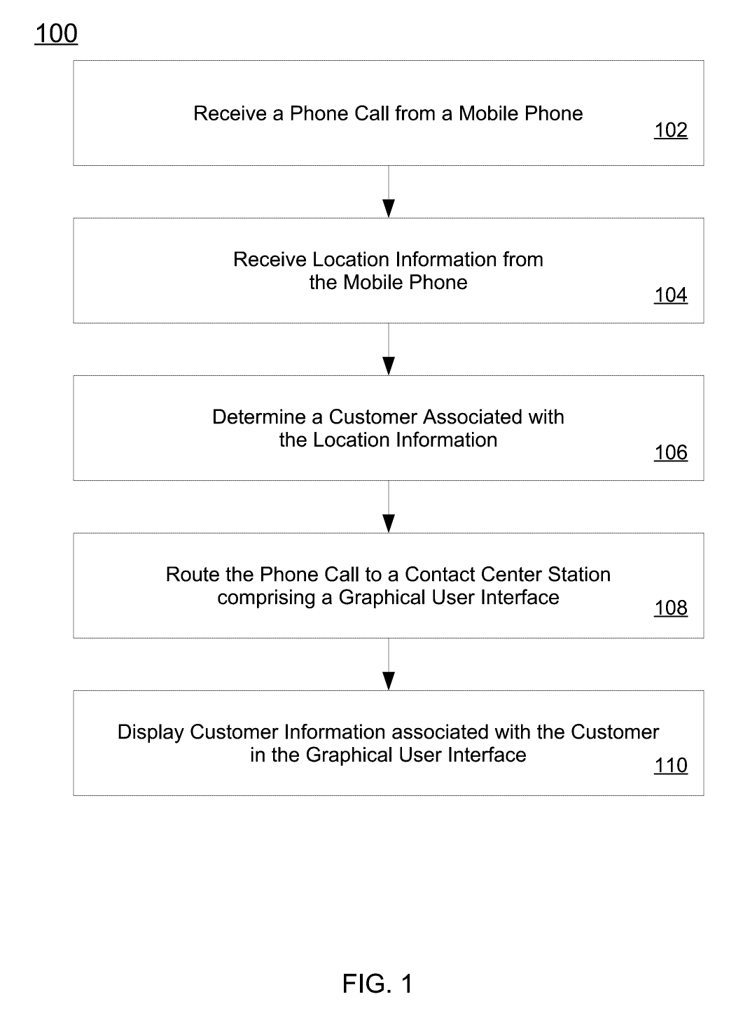

FIG. 1 is a flow chart illustrating a method according to an embodiment. As shown in FIG. 1, in step 102 of method 100, a phone call may be received. The phone call may originate from a device such as a mobile phone, tablet, or some other type of computer with location sensing functionality, such as G.P.S.

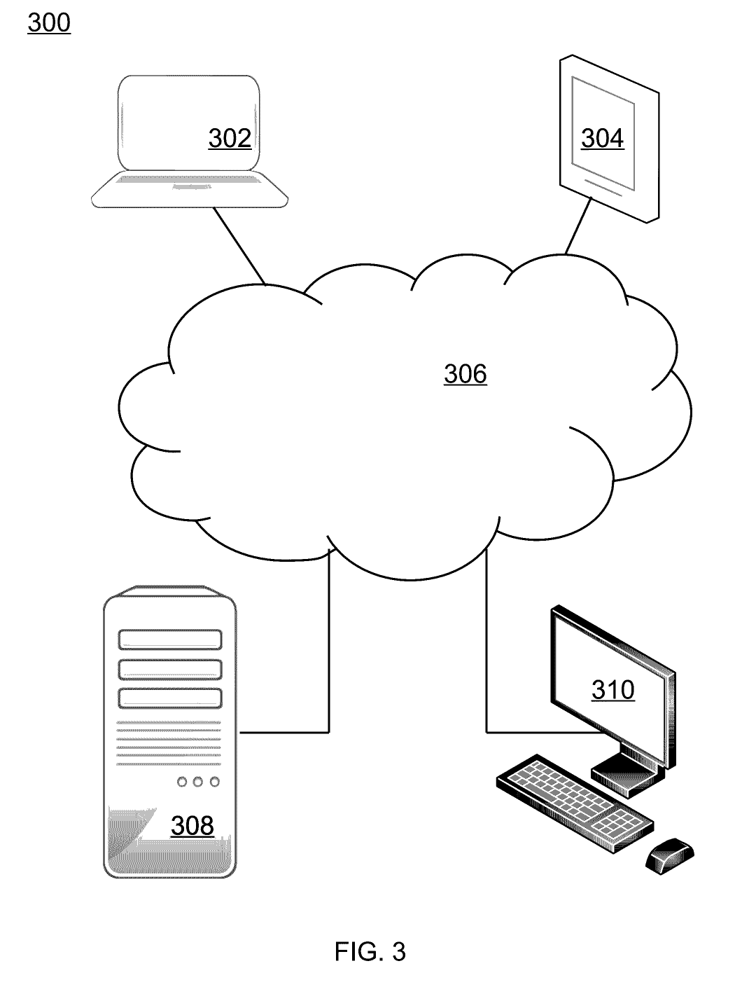

The phone call may be generated by a contact center application, such as a contact center application executing on a client device 302 as illustrated in FIG. 3 and discussed below. A contact center system, such as one illustrated in FIG. 3 and described below, may receive the phone call. In one example, a field technician may place a phone call through a contact center application executing on the field technician's mobile device. In another example, an emergency responder, such as a police officer or emergency medical technician may place a tall through a contact center application executing on a mobile communication device such as a laptop computer or tablet.

In step 104, location information may be received via the mobile phone. Location information may be automatically transmitted to a contact center system when the mobile phone places the call to the contact center system.

In one embodiment, location information may comprise G.P.S. coordinates generated by the mobile phone, and communicated to a contact center system through a contact center application executing on the mobile phone. In other embodiments, location information may comprise one or more cellular towers or wifi access points within range of the mobile phone. In yet another embodiment, location information may comprise a street address.

Location information may be automatically generated. For example, a contact center application executing on a mobile device may automatically generate G.P.S. coordinates, and transmit the G.P.S. coordinates to the contact center system when a call is placed.

In another embodiment, location information may be manually generated. In one example, a field technician may directly or indirectly specify a location. A workflow tool may display information related to a list of service calls a field technician is assigned to for the entire day. The field service technician may select a specific service call and then place a call into the contact center system. The workflow tool may automatically match a selected service call with an address, and transmit the address to the contact center system.

In step 106, a customer record may be matched with the location information. In one embodiment an address associated with the location information may be determined. G.P.S. coordinates, wifi signals, or other location information may be used to find the closest matching street address to the location information. In another embodiment, the mobile phone may transmit the address directly to the contact center system.

An address associated with the location information may then be used to find one or more matching database records in one or more databases. In one example, a contact center system may comprise a Customer Relationship Management (CRM) database comprising one or more customer records. Each customer record may be associated with a customer and include a street address associated with the customer. An address determined from the location information may be used to find a matching customer in the CRM database. In another example, a contact center system may access one or more external databases, such as a Geographic Information System (GIS) database. A person, group of people (e.g. a family), or an organization (e.g. a non-profit association, charity, or business) may be matched with the location information.

In step 108, the phone call may be routed to a contact center station comprising a graphical user interface. The graphical user interface may be generated by a contact center station executing on a device such as contact center station 310 in FIG. 3, as discussed below. In one embodiment, a contact center system may route the phone call to a queue associated with one or more contact center agents. Each contact center agent may interact with callers through a graphical user interface generated by a contact center station. If the phone call is routed to an empty queue, a contact center agent may immediately begin talking with the caller.

After the communication is routed to a contact center station, an agent may immediately begin interacting with the customer. In one alternative scenario, a communication may be routed to a contact center station but placed in a queue if the agent is unavailable. While the customer is in a queue, the system may reroute the communication to a different agent.

In step 110, customer information associated with the customer record may be displayed in the graphical user interface. Customer information may be displayed in the graphical user interface at the same time, or substantially the same time (e.g. with one second or less of a difference) as the phone call is routed to the contact center station. By displaying customer information to a contact center agent at the same time an interaction begins the overall interaction between the agent and caller may be shortened. Specifically, the amount of time a field technician has to spend explaining their specific issue may be reduced or even eliminated with a simple confirmation of the customer information.

The customer information displayed in the graphical user interface may comprise basic customer information, such as the name and location of the customer. Additional customer information displayed in the graphical user interface may comprise information related to a scheduled service call or emergency services call. For example, a person may place a call to 911 about a house fire. When an emergency responder arriving at the house fire phones a contact center, a contact center agent may immediately be presented with information such as how many people or pets may be in the house, and any other issues related to the structure, such as potential gas leaks.

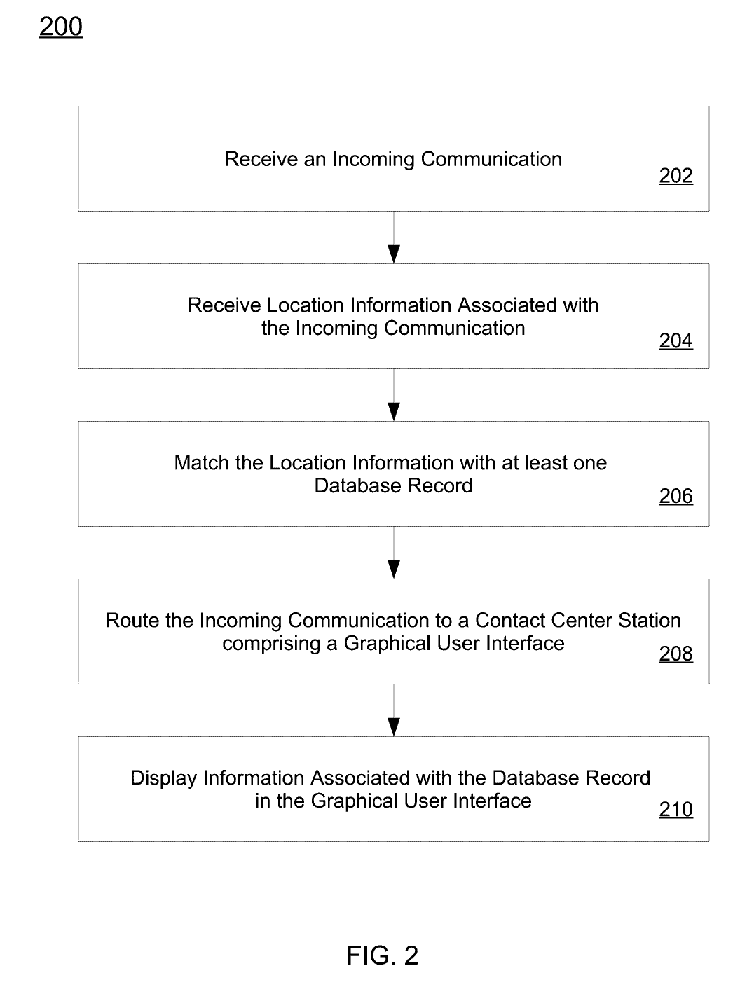

FIG. 2 is a flow chart illustrating a method according to an embodiment. As shown in FIG. 2, in step 202 of method 200, an incoming communication is received. The incoming communication may be a phone call, or a voice call. In other embodiments, the incoming communication may be a video call or an instant message chat. The incoming communication may be received by a contact center system.

A contact center system may comprise one or more contact center stations, where contact center agents access the contact center system through a graphical user interface. Interactions between contact center agents and callers may be facilitated by a contact center system, which may route communications between callers to individual or groups of contact center stations or agents. Contact center agents may handle communication interactions, or respond to incoming communications. For example, a contact center agent may interact with callers via voice calls, video chats, instant messaging, text messaging, social networking, and other forms of communication.

An incoming communication may be generated by a remote party seeking to interact with a contact center agent. A field technician may be a service provider, such as an electrician, attempting to provide a service to a customer at a remote location. An emergency responder may be responding to an emergency dispatch.

An incoming communication may be received from a client device, such as a field technician's smart phone. A server, such a server 308 as illustrated in FIG. 3 and discussed below may receive the incoming communication. In one embodiment, an incoming communication may comprise an active or open and ongoing communication channel, such as a voice call, video chat, or instant message chat. In another embodiment, an incoming communication may comprise a passive communication channel, such as an email message or SMS text message.

In step 204, location information associated with the incoming communication may be received. The location information may be received from the device originating the incoming communication, such as a smart phone, tablet, or computer. In one embodiment, an emergency responder may utilize a laptop computer to communicate with a contact center. The laptop computer may transmit location information to the contact center system concurrently with the communication.

A partner, or a member of an organization, may communicate with the organization's contact center system through a native client application executing on their communication device. A native application, such as a MacOS application, an iOS application, or an Android application, may send information, such as location information, to the contact center system before or during an interaction. In one embodiment, a client application may send regular updates to a contact center for tracking the location of partner, such as agents in the field, throughout the business day. Each regular update may include the latest G.P.S. coordinates of a field agent. Such regular updates may be used to predict upcoming needs of partners in the field.

In step 206, location information may be matched with at least one database record. In one embodiment, location information may comprise G.P.S. coordinates received from a mobile device. G.P.S. coordinates may comprise a latitude and longitude of the mobile device. The contact center system may reverse geocode the G.P.S. coordinates to determine an address associated with the location information. In another embodiment, location information may comprise an address.

The contact center system may access one or more databases to match the location information with at least one database record. A contact center system may comprise one or more internal databases, such as a CRM database. A contact center system may also be in communication with one or more external databases, such as a GIS database.

As one example, a contact center system receives a phone call from an emergency responder and location information, in the form of G.P.S. coordinates, from the device originating or making the phone call. The contact center system may reverse geocode the G.P.S. coordinates to determine a street address associated with the location information, and determine a person associated with the street address by looking up the street address in an external GIS database. Finally the contact center system may match the person, or merely the street address, with one or more database records in an internal database, such as a 911 caller database.

In some scenarios, a G.P.S. coordinate may be inaccurate, and result in an inaccurate street address termination. Location information may nonetheless be accurately matched with a database record closest to the inaccurate street address in scenarios where service calls are infrequently spaced together, and more frequently spaced apart.

In step 208, the incoming communication may be routed to a contact center station comprising a graphical user interface. After the communication is routed to a contact center station, an agent may immediately begin interacting with the customer. In one alternative scenario, a communication may be routed to a contact center station but placed in a queue if the agent is unavailable. While the customer is in a queue, the system may reroute the communication to a different agent.

The incoming communication may be matched with one or more contact center agents based on the location information or a matching database record. The incoming communication may then be routed to one or more contact center stations associated with the matching contact center agent or agents.

In step 210, information associated with the database record may be displayed in a graphical user interface. The graphical user interface may be generated by a contact center station such as contact center station 310 in FIG. 3, as discussed below.

Information associated with the database record may comprise customer information. In one example, location information is matched with a customer record in a CRM database. When the incoming communication is routed to a contact center station, information associated with the customer may be displayed in the graphical user interface of the contact center station.

### Illustrated System

FIG. 3 is a diagram illustrating a system according to an embodiment. System 300 comprises client devices 302, 304, network 306, server 308, and contact center station 310. Contact center software may execute on server 308 and facilitate communication between customers and agents over network 306. Network 306 may comprise the Internet, an intranet, or extranet, or some other type of electronic network.

Client devices 302, 304, contact center station 310, and server 308 may be in communication over network 306. In one embodiment, customers may utilize one or more client devices to interact with contact center agents through contact center software executing on server 308. A client device may comprise a network enabled device configured to communicate over network 306. Examples of client devices comprise a personal computer, such as personal computer 302, or a mobile device, such as mobile device 304.

As illustrated in FIG. 3, client device 302 comprises a personal computer and client device 304 comprises a mobile device. A mobile device may comprise a smartphone, e-reader, phablet, or a tablet. In other embodiments, a client device may comprise other types of devices. A client device may be a network-enabled device, configured to communicate with server 308 over network 306. Client devices 302, 304 may be configured to generate a graphical user interface, and execute an application within the graphical user interface. Applications operating on client devices may comprise native mobile device applications such as an iOS iPad application, a Windows Phone application, or an Android application. As one alternative, an application operating on a client device may comprise a web application accessed through a web browser.

A customer may communicate with a call center through an application operating on a client device. Such an application may be configured to determine the location of the client device through geolocation. For example, a client device may determine a general location through cell tower signals, wifi signals, and/or G.P.S.

Server 308 may be in communication with client devices 302, 304 and contact center station 310. A contact center station may comprise a network enabled device configured to communicate with server 308 over network 306. Examples of contact center stations comprise a personal computer, such as personal computer 310, or a mobile device. A contact center station in the form of a mobile device may comprise a smartphone, e-reader, phablet, or a tablet. In other embodiments, a contact center station may comprise other types of devices. Contact center station 310 may be configured to generate a graphical user interface, and execute an application within the graphical user interface. Applications operating on client devices may comprise native mobile device applications such as an iOS iPad application, a Windows Phone application, or an Android application. As one alternative, an application operating on a client device may comprise a web application accessed through a web browser.

Server 308 may receive incoming communications from client devices 302, 304. In one embodiment, an incoming communication may comprise an active or open and ongoing communication channel, such as a voice call, video chat, or instant message chat. In another embodiment, an incoming communication may comprise a passive communication channel, such as an email message or SMS text message.

Server 308 may be configured to determine location information associated with an incoming communication. In one example, server 308 may analyze caller identification information associated with a voice call to identify an area code of the voice call. The area code may correspond to a geographic region. In another example, server 308 may match an existing customer record with an incoming communication to identify a probable location of the voice call or a pertinent geographic area.

Server 308 may comprise or be in communication with a database. A database may store information about customers, contact center agents, or both. Such information stored in a database may be used to assign agents to geographic regions, determine location information associated with an incoming communication, and match incoming communications with agents based on a comparison of the location information and geographic region assignments. Some of the information stored in a database may also be accessed by server 308 and displayed on a graphical user interface shown on contact center station 310 as the incoming communication is routed to contact center station 310.

Server 308 may execute contact center software for facilitating communication between customers and agents over a network, such as customers using client devices 302, 304 and an agent using contact center station 310 over network 306. In one embodiment, an agent using contact center station 310 may access contact center software executing on server 308 over network 306. Server 308 may receive a geographic region assignment associated with an agent from contact center station 310. As server 308 receives incoming communications from client devices 302, 304, server 308 may determine location information associated with the incoming communications, and compare the location information with the geographic region assignment. The server 308 may then route incoming communications to contact center station 310 based on the comparison of the location information and the geographic region assignment. While an incoming communication is routed to a contact center station 310, information about the incoming communication may be displayed in a graphical user interface shown on contact center station 310.

### Scope

Embodiments of a subset or all and portions or all of the above may be implemented by program instructions stored in a memory medium or carrier medium and executed by a processor. A memory medium may be a transitory medium or non-transitory medium. A memory medium may include any of various types of memory devices or storage devices. The term “memory medium” is intended to include an installation medium such as a Compact Disc Read Only Memory (CD-ROM) floppy disks, tape device, a computer system memory or random access memory such as Dynamic Random Access Memory DRAM Double Data Rate Random Access Memory DDR RAM Static Random Access Memory SRAM Extended Data Out Random Access Memory EDO RAM Rambus Random Access Memory RAM etc. or a non-volatile memory such as a magnetic media e.g. a hard drive or optical storage. The memory medium may comprise other types of memory as well or combinations thereof. In addition the memory medium may be located in a first computer in which the programs are executed or may be located in a second different computer that connects to the first computer over a network such as the Internet. In some instances the second computer may provide program instructions to the first computer for execution. The term memory medium may include two or more memory mediums that may reside in different locations e.g. in different computers that are connected over a network.

In some embodiments a computer system at a respective participant location may include a memory medium on which one or more computer programs or software components according to one embodiment of the present invention may be stored For example the memory medium may store one or more programs that are executable to perform the methods described herein The memory medium may also store operating system software as well as other software for operation of the computer system.

Modifications and alternative embodiments of one or more aspects of the invention may be apparent to those skilled in the art in view of this description. Accordingly this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art rely after having the benefit of this description of the invention. Changes may be made in the elements described herein without departing from the spirit and scope of the invention as described above and below.

What is claimed is:

1. A method for displaying customer or remote party information to an agent in a contact center environment, based on location data, the method comprising the steps of:
receiving a phone call via a mobile phone associated with a remote party;
receiving, by the agent, location information via the mobile phone;
matching a customer record in one or more previously compiled databases, wherein the databases are associated with the contact center environment, with the received location information;
routing the phone call to a contact center station associated with an agent, wherein the station comprises a graphical user interface; and
displaying customer information associated with the previously compiled customer record in the graphical user interface to the agent, wherein the displaying is based on geographical location of the remote party.

2. A method for displaying customer or remote party information based on location data to a user associated with a workstation in a contact center environment, the method comprising the steps of:
receiving an incoming communication from a communication device;
receiving location information associated with the incoming communication;
matching the location information with at least one previously compiled database record;
routing the incoming communication to workstation, wherein the workstation comprises a graphical user interface; and
displaying to the user information associated with the previously compiled database record in the graphical user interface.

3. (canceled)

4. The method of claim 2, wherein the incoming communication is associated with a remote party comprising a field agent.

5. The method of claim 2, wherein the location information is automatically generated.

6. The method of claim 5, wherein the location information comprises G.P.S. coordinates, and further comprising the step of determining an address associated with the G.P.S. coordinates and wherein matching the location information with a database record comprises matching the address with a database record.

7. The method of claim 2, wherein the location information comprises an address.

8. The method of claim 2, wherein the database record is associated with the remote party, and displaying information associated with the database record comprises displaying information corresponding to the remote party.

9. The method of claim 8, wherein the remote party comprises a customer and the information comprises customer information.

10. The method of claim 2, further comprising matching the user with the incoming communication based on the database record, and the workstation is associated with the matched user.

11. The method of claim 2, wherein the incoming communication comprises a voice call.

12. The method of claim 2, wherein the incoming communication comprises video chat.

13. The method of claim 2, wherein the incoming communication comprises an instant message chat.
